(19) United States
(12) Patent Application Publication
(10) Pub. No.: US 2025/0259565 A1
(43) Pub. Date: Aug. 14, 2025

(54) EDUCATIONAL SYSTEMS AND METHODS FOR INDIVIDUALS WITH FINE MOTOR COORDINATION IMPAIRMENT

(71) Applicant: Patricia Crepeau, Burke, VA (US)

(72) Inventor: Patricia Crepeau, Burke, VA (US)

(21) Appl. No.: 18/441,792

(22) Filed: Feb. 14, 2024

(51) Int. Cl. G09B 19/00; G06F 3/01; G06F 3/04842; G06F 3/0488; G06F 3/16; G09B 5/06

(52) U.S. Cl. CPC G09B 19/003; G06F 3/016; G06F 3/04842; G06F 3/0488; G06F 3/167; G09B 5/06

(57) ABSTRACT

A computer-based education system and method for teaching a user with fine motor coordination impairment to recognize characters. Software residing on a user computing device includes first code containing characters displayable on the display and second code containing sounds playable on the speaker, each of the sounds corresponding to at least one of the characters. The software causes the user computing device to: display at least a portion of the characters in a spaced-apart arrangement each at least at a minimum size with at least a minimum space provided between the displayed characters, the minimum size and the minimum space being large enough to enable user selection by the user with fine motor coordination impairment of one of the characters using substantially only gross motor movements; and play on the speaker the sound that corresponds to the character selected by the user.

### BACKGROUND OF THE INVENTION

### Field of the Invention

The invention is directed to educational systems and methods, and more particularly to systems and methods for teaching individuals with fine motor coordination impairment how to recognize various characters or symbols.

### Description of Related Art

Typical children attend school and perform a variety of tasks such as learning letters, numbers, and other symbols, answering questions (true/false, fill in the blank, multiple choice, etc.), writing, doing linear arithmetic, doing vertical arithmetic, and the like. There are a number of atypical children and adults who for one reason or another cannot perform these tasks in a conventional manner using a writing implement and paper, or a keyboard and computer, or their voices.

One possible reason may be related to the individual's motor skills. Motor skills are motions carried out when the brain, nervous system, and muscles work together. Fine motor skills are small movements—such as grabbing something with your thumb and forefinger—that use the small muscles of the fingers, toes, wrists, lips, and tongue. Gross motor skills are the bigger movements—such as running and jumping—that use the large muscles in the arms, legs, torso, and feet. Gross motor skills are defined as the movements of the large muscles of the body. Thus, manipulating a pen or pencil or a conventional keyboard requires significant fine motor coordination, whereas hitting a large button with the palm or side of a hand falls under the category of a gross motor skill. Some individuals have fine motor coordination difficulties that make it impossible to wield a pen or type on a conventional qwerty keyboard. In addition or in the alternative, other individuals have speech impairments that may hinder or outright preclude the person from speaking in a conventional manner.

Yet having difficulty communicating is hardly indicative of not having anything to say. Often with certain assistive devices, atypical individuals are able to communicate with others. Several devices exist in this field, for example, the Tango, sold by DynaVox Mayer-Johnson of Pittsburgh, PA. The Tango is a small device, roughly 8″ by 3″, and attachable to a wheelchair. It includes several small primary buttons along with several other small control buttons. All of the controls of the Tango are small (certainly given the small overall size of the device) and are intended to be operated by the user's fingers. The small or fine motor coordination required to do so is well beyond the ability of many disabled children and also beyond the ability of those adults with fine motor coordination difficulties.

Accordingly, there is a long-felt need to provide an assistive educational device and method suitable for those with all levels of physical and cognitive ability that can be easily set up and used “out of the box” and provide access to learning of letters, numbers, and a variety of other characters.

### SUMMARY OF THE INVENTION

The above and other objects are fulfilled by the invention, which includes systems and methods of teaching individuals with fine motor coordination impairment.

In one aspect of the invention, the invention includes a computer-based education system configured to teach a user with fine motor coordination impairment to recognize characters. It includes software residing on a user computing device, the user computing device having at least one processor, a touch-sensitive display, and a speaker. The software includes first code containing characters displayable on the display and second code containing sounds playable on the speaker, each of the sounds corresponding to at least one of the characters. The at least one processor is configured to execute the software to cause the user computing device to: display on the display at least a portion of the characters in a spaced-apart arrangement each at least at a minimum size with at least a minimum space provided between adjacent of the displayed characters, the minimum size and the minimum space being large enough to enable user selection by the user with fine motor coordination impairment of one of the characters using substantially only gross motor movements; and play on the speaker the sound that corresponds to the character selected by the user when the user makes a selection of one of the characters by touching the display where the character selected by the user is being displayed.

Optionally, the user computing device further includes a haptic feedback mechanism to deliver haptic feedback to the user, and the software further includes at least one haptic feedback response, the at least one processor being configured to execute the software to cause the user computing device to deliver the at least one haptic feedback response to the user when the user makes a selection of one of the characters.

Preferably, each of the characters is one of a letter in an alphabet, a number, a punctuation mark, or a symbol. Optionally, a full set of the characters includes more than one of letters in an alphabet, numbers, punctuation marks, or symbols.

In one embodiment, the characters include a first set of characters embodied in a first shape and a second set of characters embodied in a second shape. Optionally, each of the characters include a letter in an alphabet, and the first set includes consonants in the alphabet and the second set includes vowels in the alphabet.

In one embodiment, the minimum size is approximately ¾ inches wide, and the minimum space is approximately 5/16 inches.

In another aspect of the invention, the invention includes a computer-based education method for teaching a user with fine motor coordination impairment to recognize characters. The steps of the method include: providing software residing on a user computing device, the user computing device having at least one processor, a touch-sensitive display, and a speaker, the software including first code containing characters displayable on the display and second code containing sounds playable on the speaker, each of the sounds corresponding to at least one of the characters, displaying on the display at least a portion of the characters in a spaced-apart arrangement each at least at a minimum size with at least a minimum space provided between adjacent of the displayed characters, the minimum size and the minimum space being large enough to enable user selection by the user with fine motor coordination impairment of one of the characters using substantially only gross motor movements; and playing on the speaker the sound that corresponds to the character selected by the user when the user makes a selection of one of the characters by touching the display where the character selected by the user is being displayed.

Optionally, the user computing device further includes a haptic feedback mechanism to deliver haptic feedback to the user, the software further includes at least one haptic feedback response, and the method further includes the step of delivering the at least one haptic feedback response to the user when the user makes a selection of one of the characters.

Preferably, each of the characters is one of a letter in an alphabet, a number, a punctuation mark, or a symbol. Optionally, a full set of the characters includes more than one of letters in an alphabet, numbers, punctuation marks, or symbols.

In one embodiment, the characters comprise a first set of characters embodied in a first shape and a second set of characters embodied in a second shape, and wherein each of the characters include a letter in an alphabet, and the first set includes consonants in the alphabet and the second set includes vowels in the alphabet.

In one embodiment, the method further includes the steps of setting the minimum size to at least approximately ¾ inches wide; and setting the minimum space to at least approximately 5/16 inches.

In another aspect of the invention, the invention includes a non-transitory computer-readable storage medium, comprising one or more programs for executing a computer-based method of teaching a user with fine motor coordination impairment to recognize characters via one or more processors. The computer-based method: provides software residing on a user computing device, the user computing device having at least one processor, a touch-sensitive display, and a speaker, the software including first code containing characters displayable on the display and second code containing sounds playable on the speaker, each of the sounds corresponding to at least one of the characters; displays on the display at least a portion of the characters in a spaced-apart arrangement each at least at a minimum size with at least a minimum space provided between adjacent of the displayed characters, the minimum size and the minimum space being large enough to enable user selection by the user with fine motor coordination impairment of one of the characters using substantially only gross motor movements; and plays on the speaker the sound that corresponds to the character selected by the user when the user makes a selection of one of the characters by touching the display where the character selected by the user is being displayed.

Optionally, the user computing device further has a haptic feedback mechanism to deliver haptic feedback to the user, the software further includes at least one haptic feedback response, and the computer-based method further delivers the at least one haptic feedback response to the user when the user makes a selection of one of the characters.

Preferably, each of the characters is one of a letter in an alphabet, a number, a punctuation mark, or a symbol. Optionally, a full set of the characters includes more than one of letters in an alphabet, numbers, punctuation marks, or symbols.

Optionally, the characters comprise a first set of characters embodied in a first shape and a second set of characters embodied in a second shape, and wherein each of the characters include a letter in an alphabet, and the first set includes consonants in the alphabet and the second set includes vowels in the alphabet.

Preferably, the computer-based method further sets the minimum size to at least approximately ¾ inches wide; and sets the minimum space to at least approximately 5/16 inches.

### BRIEF DESCRIPTION OF THE DRAWINGS

FIG. 1 is a schematic of a screenshot of an app version of an educational system in accordance with an embodiment of the invention.

FIG. 2 is an alternative embodiment of an app version of an educational system in accordance with an embodiment of the invention.

FIG. 3 is a block diagram of an exemplary computing environment within which various embodiments of the invention may be implemented and upon which various embodiments of the invention may be employed.

### DETAILED DESCRIPTION OF THE INVENTION AND DRAWINGS

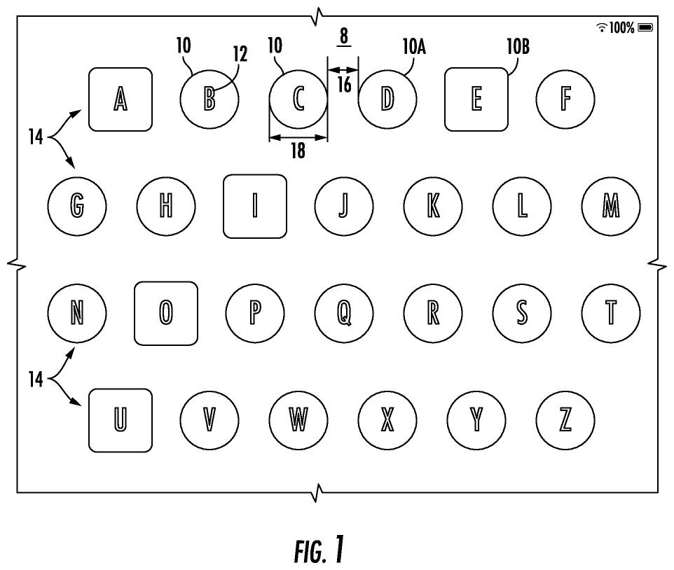

Description will now be given with reference to the attached FIGS. 1-3. It should be understood that these figures are exemplary in nature and in no way serve to limit the scope of the invention, which is defined by the claims appearing hereinbelow.

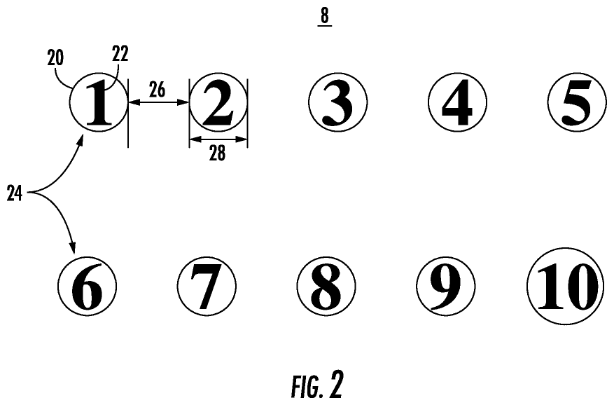

FIGS. 1 and 2 depict schematic screenshots of an app in accordance with an embodiment of the invention. The app can be run on devices such as tablets, e.g., iPad, 9th generation wi-fi, model number MK2L3LL/A (as an illustrative example only) made by Apple, Inc. of Cupertino, CA, or any similar device with a touch-sensitive screen such as a computer, tablet, phablet, phone (if large enough), laptop, notebook computer, or the like.

In FIG. 1, screen 8 is displaying thereupon a plurality of elements 10. Each element 10 includes a character, symbol, or glyph (hereinafter “character”) 12 arranged in rows 14. In the arrangement of FIG. 1, elements 10 happen to be arranged in rows 14, however any convenient or pedagogically relevant arrangement may be employed. More important are the spacing 16 between elements 10 and the size or width 18 of each element 10. Individuals with fine motor coordination impairment have difficulty with small, delicate muscle movements such as a finger pressing a button. Rather, they may have to rely on more gross motor skills such as striking something with a fist to select it on a screen. As such, elements 10 must be at least a minimum size 18 and be spaced apart at least a minimum distance 16 to enable the user to be select the desired element relatively easily without inadvertently selecting other elements. In one version of an app in accordance with the invention, width 18 is at least ¾ of an inch, while minimum spacing 16 is at least 5/16 of an inch.

Still referring to FIG. 1, the characters being displayed in elements 10 are the (e.g., capital) letters of the English alphabet. Optionally, elements 10 can be provided with a plurality of different shapes for a variety of reasons. As shown in FIG. 1, elements 10A are circles that surround consonants of the English alphabet, while elements 10B are squares that surround vowels of the English alphabet. Any other shapes (star, hexagon, octagon, irregular, etc.) are contemplated.

Referring now to FIG. 2, elements 20 are displayed on screen 8. Similar to the description above, each element 20 includes a character 22 arranged in rows 24. Elements 20 have at least a minimum spacing 26 between elements 20, and the size or width 28 of each element 20 is also set to at least a minimum size to enable the user to be select the desired element relatively easily without inadvertently selecting other elements. In one version of an app in accordance with the invention, width 28 is at least ¾ of an inch, while minimum spacing 26 is at least 5/16 of an inch.

The invention is not limited to English language characters or typical Hindu-Arabic numbers but can also include characters from other languages, as well as punctuation and other symbols. Multiple different sets of characters may be mixed and matched within the same screen display of the invention, depending on the level of the user.

In addition to displaying elements, the software of the invention also includes a number of sound files. Each sound file corresponds to one of the characters of the elements. So, as an example, referring to FIG. 1, the same way there are 26 characters 12 shown in 26 elements 10 on display 8, the software includes 26 sounds that correspond to the 26 characters. When a user selects one of the elements, the software will play on the speaker of the user computing device the sound corresponding to the selected element. So, for example, if the user were to select the element in which the letter A appears, the software will play the sound of the vocalization of the letter A.

It is expected that using the inventive software, individuals with fine motor coordination impairment will be much more readily able to learn their letters, numbers, and the like. The instructor can ask the user to look for and then press a certain element on the screen corresponding to a specific character. If the user presses the correct element, the software will play the vocalization of that letter of that character, which will provide positive reinforcement and feedback to the user.

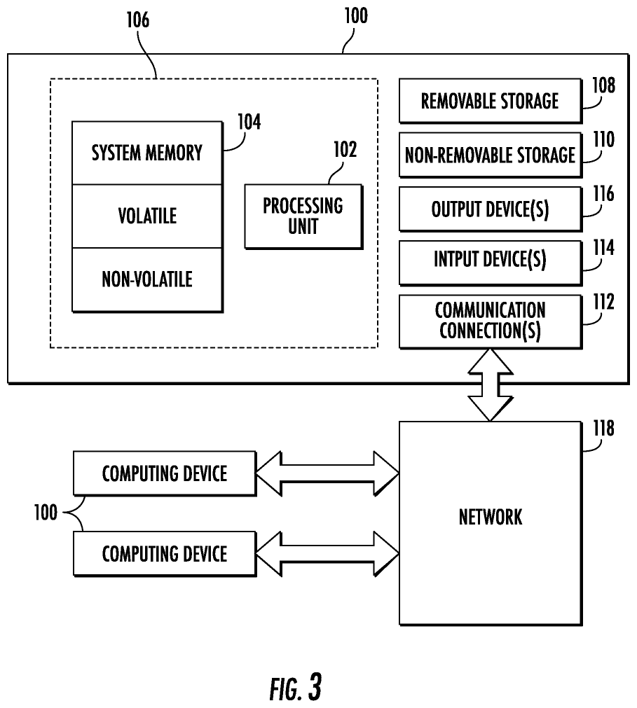

FIG. 3 depicts an exemplary computing environment in which various embodiments of the invention may be implemented and upon which various embodiments of the invention may be employed. The computing system environment is only one example of a suitable computing environment and is not intended to suggest any limitation as to the scope of use or functionality. Numerous other general purpose or special purpose computing system environments or configurations may be used. Examples of well-known computing systems, environments, and/or configurations that may be suitable for use include, but are not limited to, personal electronic devices such as smart phones and smart watches, tablet computers, personal computers (PCs), server computers, handheld or laptop devices, multi-processor systems, microprocessor-based systems, network PCs, minicomputers, mainframe computers, embedded systems, distributed computing environments that include any of the above systems or devices, and the like.

Computer-executable instructions such as program modules executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 3, an exemplary system for implementing aspects described herein includes a computing device, such as computing device 100. In its most basic configuration, computing device 100 typically includes at least one processing unit 102 and memory 104. Depending on the exact configuration and type of computing device, memory 104 may be volatile (such as random access memory (RAM)), non-volatile (such as read-only memory (ROM), flash memory, etc.), or some combination of the two. This most basic configuration is illustrated in FIG. 3 by dashed line 106. Computing device 100 may have additional features/functionality. For example, computing device 100 may include additional storage (removable and/or non-removable) including, but not limited to, magnetic or optical disks or tape. Such additional storage is illustrated in FIG. 3 by removable storage 108 and non-removable storage 110. Computing device 100 as used herein may be either a physical hardware device, a virtual device, or a combination thereof.

Computing device 100 typically includes or is provided with a variety of computer-readable media. Computer-readable media can be any available media that can be accessed by computing device 100 and includes both volatile and non-volatile media, removable and non-removable media. By way of example, and not limitation, computer-readable media may comprise computer storage media and communication media.

Computer storage media includes volatile and non-volatile, removable and non-removable media implemented in any method or technology for storage of information such as computer-readable instructions, data structures, program modules or other data. Memory 104, removable storage 108, and non-removable storage 110 are all examples of computer storage media. Computer storage media includes, but is not limited to, Random Access Memory (RAM), Read-Only Memory (ROM), electrically erasable programmable read-only memory (EEPROM), flash memory or other memory technology, compact disc read-only memory (CD-ROM), digital versatile disks (DVD) or other optical storage, magnetic cassettes, magnetic tape, magnetic disk storage or other magnetic storage devices, or any other medium which can be used to store the desired information and which can accessed by computing device 100. Any such computer storage media may be part of computing device 100.

Computing device 100 may also contain communications connection(s) 112 that allow the device to communicate with other devices. Each such communications connection 112 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. The term computer-readable media as used herein includes both storage media and communication media.

Computing device 100 may also have input device(s) 114 such as keyboard, mouse, pen, voice input device, touch input device, etc. Output device(s) 116 such as a display, speakers, printer, etc. may also be included. All these devices are generally known and therefore need not be discussed in any detail herein except as provided.

Notably, computing device 100 may be one of a plurality of computing devices 100 inter-connected by a network 118, as is shown in FIG. 3. As may be appreciated, the network 118 may be any appropriate network; each computing device 100 may be connected thereto by way of a connection 112 in any appropriate manner, and each computing device 100 may communicate with one or more of the other computing devices 100 in the network 118 in any appropriate manner. For example, the network 118 may be a wired or wireless network within an organization or home or the like, and may include a direct or indirect coupling to an external network such as the internet or the like.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as universal serial bus (USB) flash drives, Secure Digital (SD) memory cards, CD-ROMs, hard drives, or any other machine-readable storage medium wherein, when the program code is loaded into and executed by a machine, such as a computer, the machine becomes an apparatus for practicing the presently disclosed subject matter.

In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application-program interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language, and combined with hardware implementations.

Although exemplary embodiments may refer to utilizing aspects of the presently disclosed subject matter in the context of one or more stand-alone computer systems, the subject matter is not so limited, but rather may be implemented in connection with any computing environment, such as a network 118 or a distributed computing environment. Still further, aspects of the presently disclosed subject matter may be implemented in or across a plurality of processing chips or devices, and storage may similarly be effected across a plurality of devices in a network 118. Such devices might include personal computers, network servers, and handheld devices, for example.

In a preferred embodiment, the letters in the alphabet (or the numbers, or the like) are simply stored in the code. Since there are only 26 (or 10) of them, the software generates a button for each letter. The accompanying sounds may be, for example, standard iOS resources stored within the app package. Alternatively, the code containing characters displayable on the display and the code containing sounds playable on the speaker may be in separate files, databases, or remotely downloadable from the user computing device so that different sets of characters and corresponding sounds may be used, taught, and learnt.

Additionally, haptic feedback (e.g., vibration) may be provided when the user properly selects an element, as is common on many devices with touch-sensitive screens. Providing haptic feedback may assist the user to know that their touch of the screen was successful prior to and in addition to the sound being played. Haptic feedback could all be the same for each character (e.g., a short single vibration), or it could take the form of different patterns of vibration for each character (e.g., the same number of buzzes as the number being selected, the Morse code version of the letter being selected, or the like).

It should be understood that, in the context of this disclosure, “at least one of” followed by a series of elements means any one of the elements in the series or any combination of the elements in the series, including all of the elements. So, for example, a recitation of “at least one of A, B, or C” means any of A, B, C, A+B, A+C, B+C, or A+B+C.

Having described certain embodiments of the invention, it should be understood that the invention is not limited to the above description or the attached exemplary drawings. Rather, the scope of the invention is defined by the claims appearing hereinbelow and includes any equivalents thereof as would be appreciated by one of ordinary skill in the art.

What is claimed is:

1. A computer-based education system configured to teach a user with fine motor coordination impairment to recognize characters, comprising:
software residing on a user computing device, the user computing device having at least one processor, a touch-sensitive display, and a speaker, said software including
first code containing characters displayable on the display;
second code containing sounds playable on the speaker, each of said sounds corresponding to at least one of said characters,
the at least one processor being configured to execute the software to cause the user computing device to:
display on the display at least a portion of said characters in a spaced-apart arrangement each at least at a minimum size with at least a minimum space provided between adjacent of said displayed characters, said minimum size and said minimum space being large enough to enable user selection by the user with fine motor coordination impairment of one of said characters using substantially only gross motor movements;
play on the speaker said sound that corresponds to said character selected by the user when the user makes a selection of one of said characters by touching the display where said character selected by the user is being displayed.

2. A computer-based education system configured to teach a user with fine motor coordination impairment to recognize characters according to claim 1, the user computing device further having a haptic feedback mechanism to deliver haptic feedback to the user, said software further including at least one haptic feedback response, the at least one processor being configured to execute the software to cause the user computing device to deliver the at least one haptic feedback response to the user when the user makes a selection of one of said characters.

3. A computer-based education system configured to teach a user with fine motor coordination impairment to recognize characters according to claim 1, wherein each of said characters is one of a letter in an alphabet, a number, a punctuation mark, or a symbol.

4. A computer-based education system configured to teach a user with fine motor coordination impairment to recognize characters according to claim 3, wherein a full set of the characters includes more than one of letters in an alphabet, numbers, punctuation marks, or symbols.

5. A computer-based education system configured to teach a user with fine motor coordination impairment to recognize characters according to claim 1, wherein said characters comprise a first set of characters embodied in a first shape and a second set of characters embodied in a second shape.

6. A computer-based education system configured to teach a user with fine motor coordination impairment to recognize characters according to claim 5, wherein each of said characters include a letter in an alphabet, and said first set includes consonants in the alphabet and said second set includes vowels in the alphabet.

7. A computer-based education system configured to teach a user with fine motor coordination impairment to recognize characters according to claim 1, wherein said minimum size is approximately ¾ inches wide.

8. A computer-based education system configured to teach a user with fine motor coordination impairment to recognize characters according to claim 1, wherein said minimum space is approximately 5/16 inches.

9. A computer-based education method for teaching a user with fine motor coordination impairment to recognize characters, comprising the steps of:
providing software residing on a user computing device, the user computing device having at least one processor, a touch-sensitive display, and a speaker, the software including first code containing characters displayable on the display and second code containing sounds playable on the speaker, each of the sounds corresponding to at least one of the characters,
displaying on the display at least a portion of the characters in a spaced-apart arrangement each at least at a minimum size with at least a minimum space provided between adjacent of the displayed characters, the minimum size and the minimum space being large enough to enable user selection by the user with fine motor coordination impairment of one of the characters using substantially only gross motor movements; and
playing on the speaker the sound that corresponds to the character selected by the user when the user makes a selection of one of the characters by touching the display where the character selected by the user is being displayed.

10. A computer-based education method for teaching a user with fine motor coordination impairment to recognize characters according to claim 9, the user computing device further having a haptic feedback mechanism to deliver haptic feedback to the user, the software further including at least one haptic feedback response, further comprising the step of delivering the at least one haptic feedback response to the user when the user makes a selection of one of the characters.

11. A computer-based education method for teaching a user with fine motor coordination impairment to recognize characters according to claim 9, wherein each of the characters is one of a letter in an alphabet, a number, a punctuation mark, or a symbol.

12. A computer-based education method for teaching a user with fine motor coordination impairment to recognize characters according to claim 11, wherein a full set of the characters includes more than one of letters in an alphabet, numbers, punctuation marks, or symbols.

13. A computer-based education method for teaching a user with fine motor coordination impairment to recognize characters according to claim 9, wherein the characters comprise a first set of characters embodied in a first shape and a second set of characters embodied in a second shape, and wherein each of the characters include a letter in an alphabet, and the first set includes consonants in the alphabet and the second set includes vowels in the alphabet.

14. A computer-based education method for teaching a user with fine motor coordination impairment to recognize characters according to claim 9, further comprising the steps of:
setting the minimum size to at least approximately ¾ inches wide; and
setting the minimum space to at least approximately 5/16 inches.

15. A non-transitory computer-readable storage medium, comprising one or more programs for executing a computer-based method of teaching a user with fine motor coordination impairment to recognize characters via one or more processors, wherein the computer-based method:
provides software residing on a user computing device, the user computing device having at least one processor, a touch-sensitive display, and a speaker, the software including first code containing characters displayable on the display and second code containing sounds playable on the speaker, each of the sounds corresponding to at least one of the characters,
displays on the display at least a portion of the characters in a spaced-apart arrangement each at least at a minimum size with at least a minimum space provided between adjacent of the displayed characters, the minimum size and the minimum space being large enough to enable user selection by the user with fine motor coordination impairment of one of the characters using substantially only gross motor movements; and
plays on the speaker the sound that corresponds to the character selected by the user when the user makes a selection of one of the characters by touching the display where said character selected by the user is being displayed.

16. A non-transitory computer-readable storage medium, comprising one or more programs for executing a computer-based method of teaching a user with fine motor coordination impairment to recognize characters via one or more processors according to claim 15, the user computing device further having a haptic feedback mechanism to deliver haptic feedback to the user, the software further including at least one haptic feedback response, said computer-based method further delivers the at least one haptic feedback response to the user when the user makes a selection of one of the characters.

17. A non-transitory computer-readable storage medium, comprising one or more programs for executing a computer-based method of teaching a user with fine motor coordination impairment to recognize characters via one or more processors according to claim 15, wherein each of the characters is one of a letter in an alphabet, a number, a punctuation mark, or a symbol.

18. A non-transitory computer-readable storage medium, comprising one or more programs for executing a computer-based method of teaching a user with fine motor coordination impairment to recognize characters via one or more processors according to claim 17, wherein a full set of the characters includes more than one of letters in an alphabet, numbers, punctuation marks, or symbols.

19. A non-transitory computer-readable storage medium, comprising one or more programs for executing a computer-based method of teaching a user with fine motor coordination impairment to recognize characters via one or more processors according to claim 15, wherein the characters comprise a first set of characters embodied in a first shape and a second set of characters embodied in a second shape, and wherein each of the characters include a letter in an alphabet, and the first set includes consonants in the alphabet and the second set includes vowels in the alphabet.

20. A non-transitory computer-readable storage medium, comprising one or more programs for executing a computer-based method of teaching a user with fine motor coordination impairment to recognize characters via one or more processors according to claim 15, said computer-based method further:
sets the minimum size to at least approximately ¾ inches wide; and
sets the minimum space to at least approximately 5/16 inches.
